(19) United States
(12) Patent Application Publication
(10) Pub. No.: US 2016/0269487 A1
(43) Pub. Date: Sep. 15, 2016

(54) CONTROL APPARATUS FOR USE IN DISTRIBUTED CONTROL SYSTEM AND UNITS

(71) Applicant: MITSUBISHI ELECTRIC CORPORATION, Tokyo (JP)

(72) Inventor: Hiroshi ABE, Tokyo (JP)

(73) Assignee: Mitsubishi Electric Corporation, Tokyo (JP)

(21) Appl. No.: 14/910,733

(22) PCT Filed: Oct. 2, 2014
(86) PCT No.: PCT/JP2014/076447

§ 371 Date: Feb. 8, 2016

(51) Int. Cl. H04L 29/08; G05B 11/01; G05B 15/02

(52) U.S. Cl. CPC H04L 67/125; G05B 15/02; G05B 11/01

(57) ABSTRACT

A remote unit includes a base unit having a function to communicate through a network and an add-on unit connected through the base unit to the network. The base unit includes a CPU that receives from a programmable logic controller through the network an add-on unit parameter that determines the operation of the add-on unit and a base unit internal memory that stores the add-on unit parameter received from the programmable logic controller. The add-on unit includes a CPU that acquires from the base unit an add-on unit parameter stored in the base unit internal memory to reflect the add-on unit parameter in the operation of the add-on unit.

### FIELD

The present invention relates to a control apparatus for use in a distributed control system for industry.

### BACKGROUND

Control apparatuses included in a distributed control system for use in industry are referred to as remote units. A plurality of remote units are typically used, with each remote unit including parameters set for determining its operation. Hence, when a remote unit has failed and is replaced, it is necessary to read the parameters from the remote unit or have backup parameters available by reading them in advance and set the parameters in a new unit after the replacement.

Examples of parameters include setting information for a remote unit to operate, adjustment information for absorbing individual differences between units, and the like. Examples of the adjustment information include an offset and a gain in an analog unit.

In some cases, a remote unit includes two units. Of the units included in a remote unit, a unit that has a network communication function is referred to as a “base unit.” Of the units included in a remote unit, a unit that has no network communication function and is used by being connected to the base unit is referred to as an “add-on unit.” In the case of a remote unit that includes a base unit and an add-on unit, parameters need to be written to both of the base unit and the add-on unit.

A method is disclosed in Patent Literature 1, by which a parameter is written to a remote unit through a network.

A remote terminal device is disclosed in Patent Literature 2, which includes a communication unit and an I/O unit that is used in an attached form to the communication unit and backs up setting value information for operating the remote terminal device in a nonvolatile IC inside the communication unit.

### CITATION LIST

### Patent Literature

Patent Literature 1: Japanese Patent Application Laid-Open No. 2009-15401
Patent Literature 2: Japanese Patent Application Laid-Open No. 2007-102764

### SUMMARY

### Technical Problem

To set a parameter in a remote unit, it is necessary to connect a CPU unit that manages a network and a computer, and operate a dedicated tool that works on the computer.

Additionally, in a distributed control system, a peripheral device that controls the system and a remote unit are often placed away from each other, and due to this, when a unit is replaced for reasons such as the failure of the unit, it is necessary for a user to re-install a new remote unit and then move to a programmable logic controller, which performs the control, so as to transmit a parameter writing signal. Hence, it takes time and effort to replace a remote unit.

Moreover, a remote unit that includes a base unit and an add-on unit involves a frequent replacement of units due to the presence of the two units. Thus, a remote unit that includes a base unit and an add-on unit tends to require the writing of parameters into a replacing unit quite frequently.

The inventions disclosed in Patent Literatures 1 and 2 have no ability to resolve these problems.

The present invention has been achieved in view of the above, and an object of the present invention is to provide a control apparatus for use in a distributed control system, which is capable of conveying parameters used in a previous unit to a unit that has replaced the previous unit reliably and automatically when the unit is replaced.

### Solution to Problem

In order to solve the aforementioned problems, a control apparatus for use in a distributed control system according to one aspect of the present invention, in which the control apparatus is connected through a field network to a controller that serves as a master station and serves as a remote station of the distributed control system includes: a base unit having a function to communicate through the field network and an add-on unit connected to the field network through the base unit, wherein the base unit includes a base unit central controller that receives from the controller through the field network an add-on unit parameter that determines an operation of the add-on unit and a base unit internal memory that stores the add-on unit parameter received from the controller, and the add-on unit includes an add-on unit central controller, which, at starting up of the control apparatus for use in a distributed control system, acquires from the base unit the add-on unit parameter stored in the base unit internal memory and reflects the add-on unit parameter in the operation of the add-on unit.

### Advantageous Effects of Invention

A control apparatus for use in a distributed control system according to the present invention produces an effect of enabling to convey parameters used in a previous unit to a unit that has replaced the previous unit reliably and automatically when the unit is replaced.

### BRIEF DESCRIPTION OF DRAWINGS

FIG. 1 is a configuration diagram of a distributed control system according to a first embodiment of the present invention.

FIG. 2 is a block diagram illustrating the configuration of a remote unit according to the first embodiment.

FIG. 3 is an exterior diagram of the remote unit according to the first embodiment.

FIG. 4 is a flowchart illustrating the flow of parameter setting processing of the distributed control system according to the first embodiment.

FIG. 5 is a flowchart illustrating the flow of the parameter setting processing of the distributed control system according to the first embodiment.

FIG. 6 is a flowchart illustrating the flow of start-up processing of the remote unit after the replacement of an add-on unit in the distributed control system according to the first embodiment.

FIG. 7 is a block diagram illustrating the configuration of a remote unit according to a second embodiment of the present invention.

FIG. 8 is a flowchart illustrating the flow of parameter setting processing of a distributed control system according to the second embodiment.

FIG. 9 is a flowchart illustrating the flow of the parameter setting processing of the distributed control system according to the second embodiment.

FIG. 10 is a flowchart illustrating the flow of start-up processing of the remote unit after the replacement of a base unit in the distributed control system according to the second embodiment.

FIG. 11 is a block diagram illustrating the configuration of a remote unit according to a third embodiment of the present invention.

FIG. 12 is a flowchart illustrating the flow of parameter setting processing of a distributed control system according to the third embodiment.

FIG. 13 is a flowchart of start-up processing of the remote unit after the replacement of an add-on unit in the distributed control system according to the third embodiment.

### DESCRIPTION OF EMBODIMENTS

Exemplary embodiments of a control apparatus for use in a distributed control system according to the present invention will now described in detail with reference to the drawings. The present invention is not limited to the present embodiments.

### First Embodiment

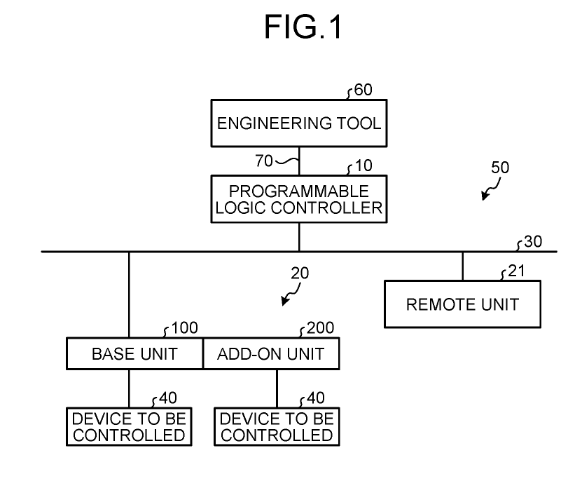

FIG. 1 is a configuration diagram of a distributed control system according to a first embodiment of the present invention. A distributed control system 50 includes a programmable logic controller 10, which is a controller serving as a master station, and remote units 20 and 21, which serve as remote stations, connected through a field network 30. In the distributed control system 50, the remote unit 20 is a control apparatus for use in a distributed control system according to the first embodiment of the present invention, while the remote unit 21 is a common control apparatus for use in a distributed control system. Note that the distributed control system 50 can be configured with a plurality of control apparatuses for use in a distributed control system according to the first embodiment of the present invention.

The remote unit 20 includes a base unit 100 and an add-on unit 200. The base unit 100 is connected to the field network 30 and has a function to communicate with the programmable logic controller 10 or the remote unit 21 through the field network 30. The add-on unit 200 has no function to communicate with the programmable logic controller 10 or with the remote unit 21 through the field network 30, and is connected to the field network 30 through the base unit 100. The field network 30 is a network, the primary purpose of which is to allow for the transmission and reception of a control signal and data between the programmable logic controller 10, which is the master station, and the remote units 20 and 21, which are the remote stations.

The base unit 100 and the add-on unit 200 are each connected to a control-target device (hereinafter just referred to as a “control-target device”) 40. The base unit 100 and the add-on unit 200 each perform processing of obtaining a signal output by the corresponding control-target device 40 and outputting a control signal to the corresponding control-target device 40.

When a setting task is performed for the distributed control system 50, the programmable logic controller 10 is connected to an engineering tool 60 through a control network 70. The engineering tool 60 is a computer that includes software installed therein for setting of the programmable logic controller 10. The control network 70 is a network, the primary purpose of which is to allow the programmable logic controller 10, which is the master station, to transmit and receive a control signal and data to and from another device that is not a remote station. A user of the distributed control system 50 operates the engineering tool 60 to input thereto settings for the programmable logic controller 10 and the remote units 20 and 21 and transmits the settings to the programmable logic controller 10 through the control network 70. The programmable logic controller 10 transmits the data of setting for the remote units 20 and 21 to the remote units 20 and 21 through the field network 30.

Note that the programmable logic controller 10 and the engineering tool 60 can be connected through a designated line. The programmable logic controller 10 and the engineering tool 60 do not have to be connected to each other all the time and they may be disconnected from each other when no setting task is performed.

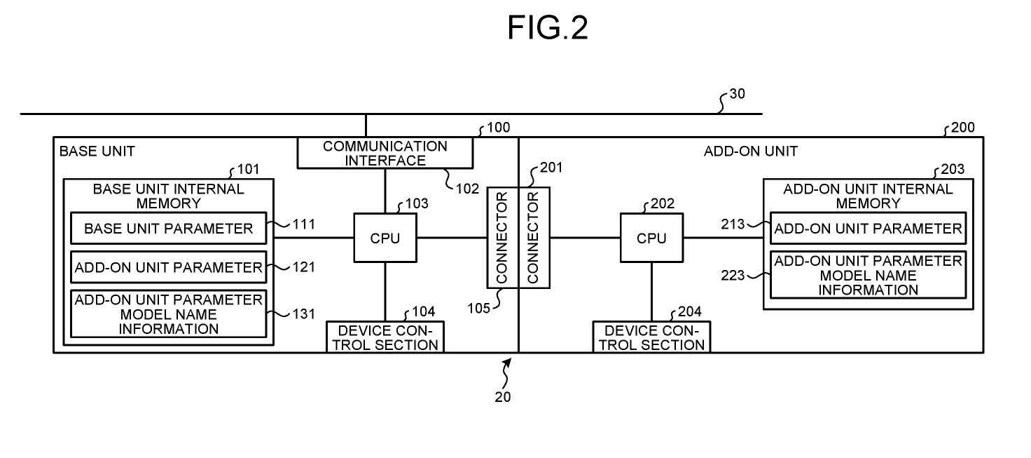

FIG. 2 is a block diagram illustrating the configuration of the remote unit according to the first embodiment. The base unit 100 includes a base unit internal memory 101, a communication interface 102, a CPU (central processing unit) 103, a device control section 104, and a connector 105. The base unit internal memory 101 is a memory that stores information and can be a nonvolatile memory. Note, however, that the base unit internal memory 101 is not limited to a nonvolatile memory. The base unit internal memory 101 stores a base unit parameter 111, an add-on unit parameter 121, and add-on unit parameter model name information 131. The communication interface 102 is an interface for communicating with the programmable logic controller 10 or the remote unit 21 through the field network 30. The CPU 103 is a functional unit that provides centralized control on the entire base unit 100, and it is a base unit central controller that receives an add-on unit parameter, which determines the operation of the add-on unit 200, from the programmable logic controller 10 through the field network 30 and causes the add-on unit parameter to be stored in the base unit internal memory 101. The device control section 104 performs processing of obtaining information from the control-target device 40 and outputting a control signal to the control-target device 40. The connector 105 is a connector for connecting the add-on unit 200.

The add-on unit 200 includes a connector 201, a CPU 202, an add-on unit internal memory 203, and a device control section 204. The connector 201 is a connector for connecting thereto the base unit 100. The CPU 202 is a functional unit that provides centralized control on the entire add-on unit 200, and it is an add-on unit central processor that, at the starting up of the remote unit 20, acquires from the base unit 100 the add-on unit parameter 121 stored in the base unit internal memory 101 and reflects it in the operation of the add-on unit 200. The add-on unit internal memory 203 is a memory that stores information and can be a nonvolatile memory. Note, however, that the add-on unit internal memory 203 is not limited to a nonvolatile memory. The add-on unit internal memory 203 stores an add-on unit parameter 213 and add-on unit parameter model name information 223. The device control section 204 performs processing of obtaining information from the control-target device 40 and outputting a control signal to the control-target device 40.

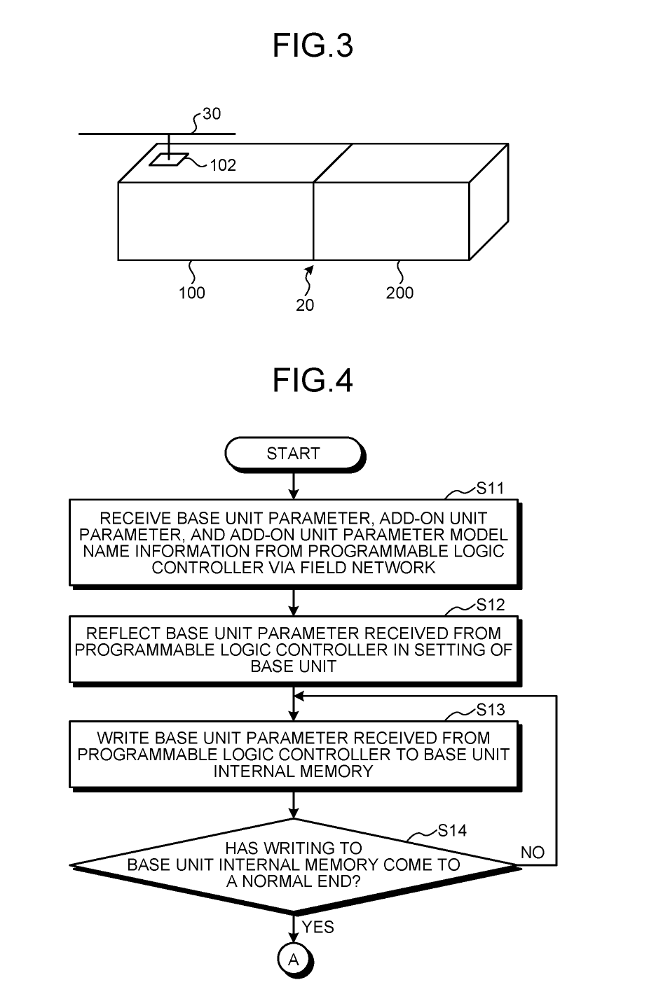

FIG. 3 is an exterior diagram of the remote unit according to the first embodiment. The remote unit 20 is connected to the field network 30 through the communication interface 102 of the base unit 100.

In general, an add-on unit to be connected to a base unit can be selected from types corresponding to the connection with the base unit. Hence, to enable identification of the type of the add-on unit 200, the add-on unit parameter model name information 223, which is unique to a unit, is stored in the add-on unit internal memory 203. The add-on unit parameter model name information 223 is normally not rewritten to be changed.

A user of the distributed control system 50 operates the engineering tool 60 to input thereto a base unit parameter and an add-on unit parameter.

The base unit parameter and the add-on unit parameter input to the engineering tool 60 are transmitted to the programmable logic controller 10 through the control network 70. The programmable logic controller 10 transmits the base unit parameter and the add-on unit parameter received from the engineering tool 60 to the remote unit 20 through the field network 30.

The remote unit 20, which has received the base unit parameter and the add-on unit parameter from the programmable logic controller 10, performs parameter setting processing to reflect in the setting the base unit parameter and the add-on unit parameter that have been received.

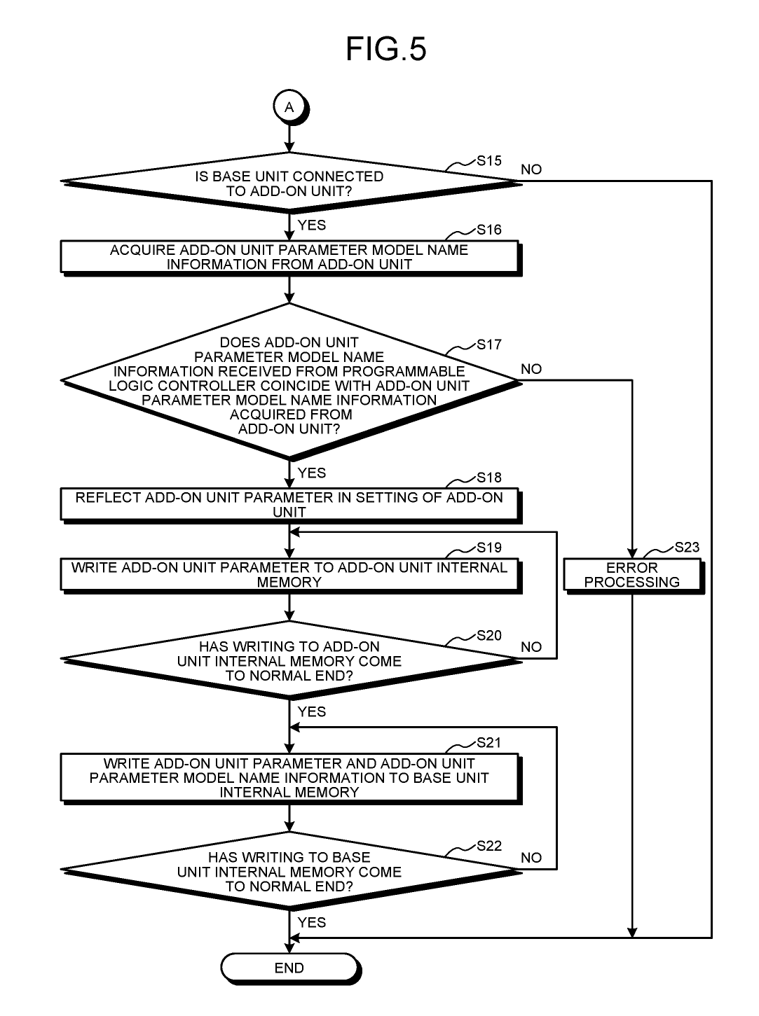

FIGS. 4 and 5 are flowcharts illustrating the flow of the parameter setting processing of the distributed control system according to the first embodiment. Here, it is assumed that parameters already set in the base unit 100 and the add-on unit 200 are updated for the explanation of the flow of the processing. In step S11, the CPU 103 receives a base unit parameter, an add-on unit parameter, and add-on unit parameter model name information from the programmable logic controller 10 via the field network 30. The add-on unit parameter model name information received by the CPU 103 indicates for which type of add-on units the add-on unit parameter received with the add-on unit parameter model name information is. Add-on unit parameter model name information is usually included in an add-on unit parameter.

In step S12, the CPU 103 reflects the base unit parameter received from the programmable logic controller 10 in the setting of the base unit 100. That is, the CPU 103 uses the base unit parameter received from the programmable logic controller 10 for controlling the entire base unit 100. This enables the base unit 100 to operate according to the base unit parameter received from the programmable logic controller 10.

In step S13, the CPU 103 writes the base unit parameter received from the programmable logic controller 10 to the base unit internal memory 101. The base unit parameter written by the CPU 103 to the base unit internal memory 101 is the base unit parameter 111.

In step S14, the CPU 103 determines whether or not the writing into the base unit internal memory 101 has come to a normal end. If the writing into the base unit internal memory 101 has not come to the normal end (step S14: No), the flowchart returns to step S13, where the CPU 103 writes the base unit parameter received from the programmable logic controller 10 to the base unit internal memory 101. If the writing into the base unit internal memory 101 has come to the normal end (step S14: Yes), the flowchart proceeds to step S15.

In step S15, the CPU 103 checks whether the add-on unit 200 is connected to the base unit 100. If the add-on unit 200 is not connected to the base unit 100 (step S15: No), the parameter setting processing is finished. If the base unit 100 is connected to the add-on unit 200 (step S15: Yes), the flowchart proceeds to step S16.

In step S16, the CPU 103 acquires the add-on unit parameter model name information 223 from the add-on unit 200. Specifically, the CPU 103 requests the CPU 202 to read the add-on unit parameter model name information 223 stored in the add-on unit internal memory 203. In response to the request from the CPU 103, the CPU 202 reads the add-on unit parameter model name information 223 from the add-on unit internal memory 203 and transmits it to the CPU 103.

In step S17, the CPU 103 checks whether the add-on unit parameter model name information received from the programmable logic controller 10 coincides with the add-on unit parameter model name information 223 acquired from the add-on unit 200. If the add-on unit parameter model name information received from the programmable logic controller 10 coincides with the add-on unit parameter model name information 223 received from the CPU 202 (step S17: Yes), the flowchart proceeds to step S18. Note that, if the add-on unit parameter model name information received from the programmable logic controller 10 coincides with the add-on unit parameter model name information 223 acquired from the add-on unit 200, the add-on unit parameter received by the CPU 103 from the programmable logic controller 10 would be suitable for the add-on unit 200 presently connected.

In step S18, the CPU 103 transmits the add-on unit parameter received from the programmable logic controller 10 to the add-on unit 200. The CPU 202 reflects the add-on unit parameter received from the CPU 103 in the setting of the add-on unit 200. That is, the CPU 202 uses the add-on unit parameter that the base unit 100 has received from the programmable logic controller 10 for controlling the entire add-on unit 200. This enables the add-on unit 200 to operate according to the add-on unit parameter that the base unit 100 has received from the programmable logic controller 10.

In step S19, the CPU 202 writes the add-on unit parameter received from the base unit 100 to the add-on unit internal memory 203. The add-on unit parameter written by the CPU 202 to the add-on unit internal memory 203 is the add-on unit parameter 213.

In step S20, the CPU 202 determines whether or not the writing into the add-on unit internal memory 203 has come to a normal end. If the writing into the add-on unit internal memory 203 has not come to the normal end (step S20: No), the flowchart returns to step S19 where the CPU 202 writes the add-on unit parameter received from the base unit 100 to the add-on unit internal memory 203. On the other hand, if the writing into the add-on unit internal memory 203 has come to the normal end (step S20: Yes), the flowchart proceeds to step S21.

In step S21, the CPU 103 writes the add-on unit parameter and the add-on unit parameter model name information received from the programmable logic controller 10 to the base unit internal memory 101. The add-on unit parameter written by the CPU 103 to the base unit internal memory 101 is the add-on unit parameter 121. The add-on unit parameter model name information written by the CPU 103 to the base unit internal memory 101 is the add-on unit parameter model name information 131.

In step S22, the CPU 103 determines whether or not the writing into the base unit internal memory 101 has come to a normal end. If the writing into the base unit internal memory 101 has not come to the normal end (step S22: No), the flowchart returns to step S21 where the CPU 103 writes the add-on unit parameter and the add-on unit parameter model name information received from the programmable logic controller 10 to the base unit internal memory 101. If the writing into the base unit internal memory 101 has come to the normal end (step S22: Yes), the parameter setting processing is finished.

If the add-on unit parameter model name information received from the programmable logic controller 10 does not coincide with the add-on unit parameter model name information 223 acquired from the add-on unit 200 (step S17: No), the add-on unit parameter received by the CPU 103 from the programmable logic controller 10 will not be suitable for the add-on unit 200 presently connected, and thus, in step S23, the CPU 103 performs error processing. In the error processing, an operation predetermined for each type of the base unit 100 is performed. The explanation of specifics on the error processing is omitted, as it is not an important point of the present invention.

The disagreement between the add-on unit parameter model name information received from the programmable logic controller 10 and the add-on unit parameter model name information 223 acquired from the add-on unit 200 may be attributable to an input error made by a user of the distributed control system 50 when operating the engineering tool 60 to input the base unit parameter and the add-on unit parameter.

In the explanation above, the CPU 103 performs the error processing in step S23. However, the CPU 103 may perform no error processing and the CPU 202 may continue to operate using a previously set add-on unit parameter, that is, the add-on unit parameter 213 stored in the add-on unit internal memory 203. Alternatively, the CPU 202 may operate by using a default value stored in advance in the add-on unit 200.

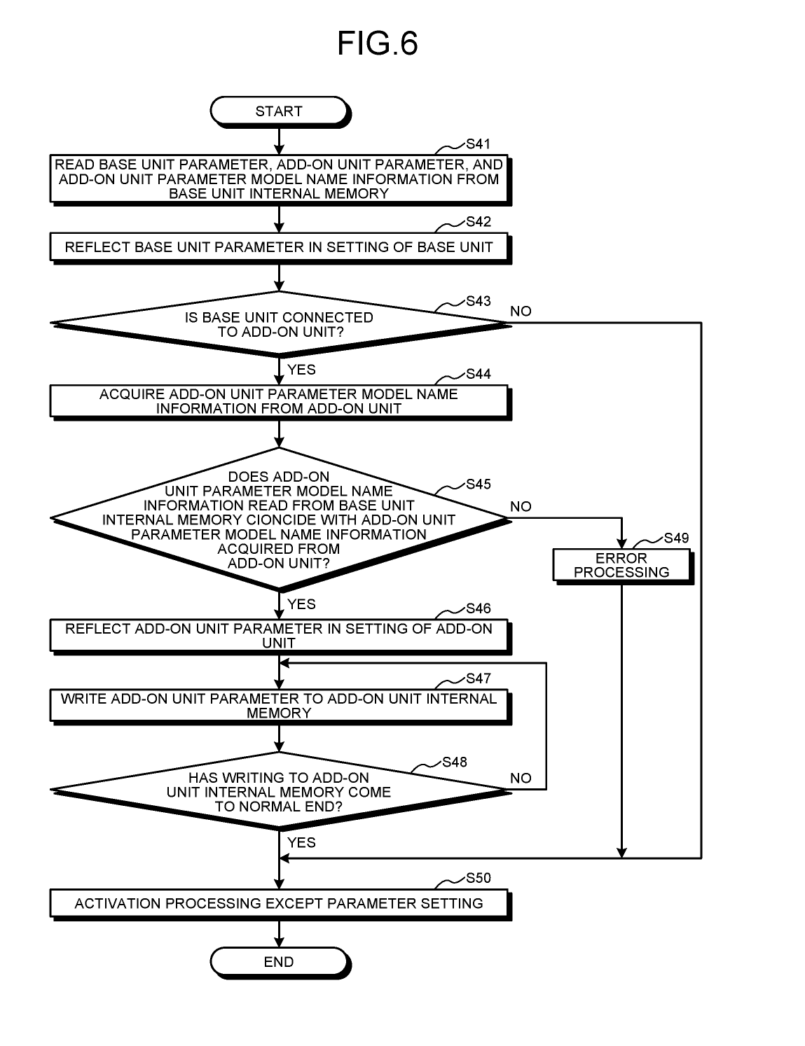

Start-up processing of the remote unit after the replacement of the add-on unit will now be described. FIG. 6 is a flowchart illustrating the flow of the start-up processing of the remote unit after the replacement of the add-on unit in the distributed control system according to the first embodiment. In step S41, the CPU 103 reads the base unit parameter 111, the add-on unit parameter 121, and the add-on unit parameter model name information 131 from the base unit internal memory 101.

In step S42, the CPU 103 reflects the base unit parameter 111 in the setting of the base unit 100. This enables the base unit 100 to operate according to the base unit parameter 111.

In step S43, the CPU 103 checks whether the add-on unit 200 is connected to the base unit 100. If the add-on unit 200 is not connected to the base unit 100 (step S43: No), the flowchart proceeds to step S50. If the add-on unit 200 is connected to the base unit 100 (step S43: Yes), the flowchart proceeds to step S44.

In step S44, the CPU 103 acquires add-on unit parameter model name information 223 from the add-on unit 200. Specifically, the CPU 103 requests a CPU 202 to read the add-on unit parameter model name information 223 stored in the add-on unit internal memory 203. In response to the request from the CPU 103, the CPU 202 reads the add-on unit parameter model name information 223 from the add-on unit internal memory 203 and transmits it to the CPU 103.

In step S45, the CPU 103 checks whether the add-on unit parameter model name information 131 read from the base unit internal memory 101 coincides with the add-on unit parameter model name information 223 acquired from the add-on unit 200. If the add-on unit parameter model name information 131 coincides with the add-on unit parameter model name information 223 (step S45: Yes), the flowchart proceeds to step S46. Note that, if the add-on unit parameter model name information 131 coincides with the add-on unit parameter model name information 223, the add-on unit parameter 121 would be suitable for the add-on unit 200 presently connected.

In step S46, the CPU 103 transmits the add-on unit parameter 121 read from the base unit internal memory 101 to the CPU 202. The CPU 202 reflects the add-on unit parameter 121 received from the CPU 103 in the setting of the add-on unit 200. This enables the add-on unit 200 to operate according to the add-on unit parameter 121 received from the programmable logic controller 10.

In step S47, the CPU 202 writes the add-on unit parameter received from the base unit 100 to the add-on unit internal memory 203. The add-on unit parameter written by the CPU 202 to the add-on unit internal memory 203 is an add-on unit parameter 213.

In step S48, the CPU 202 determines whether or not the writing into the add-on unit internal memory 203 has come to a normal end. If the writing into the add-on unit internal memory 203 has not come to the normal end (step S48: No), the flowchart returns to step S47 where the CPU 202 writes the add-on unit parameter received from the base unit 100 to the add-on unit internal memory 203. If the writing into the add-on unit internal memory 203 has come to the normal end (step S48: Yes), the flowchart proceeds to step S50.

If the add-on unit parameter model name information 131 received from the base unit internal memory 101 does not coincide with the add-on unit parameter model name information 223 received from the CPU 202 (step S45: No), the add-on unit parameter 121 stored in the base unit internal memory 101 will not be suitable for the add-on unit 200 presently connected, and thus, in step S49, the CPU 103 performs error processing, and the flowchart then proceeds to step S50.

The disagreement between the add-on unit parameter model name information 131 read from the base unit internal memory 101 and the add-on unit parameter model name information 223 received from the CPU 202 may be attributable to the add-on unit of a different type with which a user of the distributed control system 50 has replaced an add-on unit.

In the description above, the CPU 103 performs the error processing in step S49, although the CPU 103 may perform no error processing and the CPU 202 may operate using a previously set add-on unit parameter, that is, the add-on unit parameter 213 stored in the add-on unit internal memory 203. Alternatively, the CPU 202 may operate by using a default value stored in advance in the add-on unit 200. In the case of the operation by using a default value stored in advance in the add-on unit 200, it is made possible to omit to back up the add-on unit parameter 213 to the add-on unit internal memory 203.

In step S50, the CPU 103 performs start-up processing other than the parameter setting. In the case of the base unit 100 or the add-on unit 200 being an analog input unit, specific examples of the start-up processing other than the parameter setting include initial setting processing for hardware. In the case of the base unit 100 or the add-on unit 200 being an analog output unit, specific examples of the start-up processing other than the parameter setting include a charging time setting for a capacitor.

As described above, the remote unit reflects the add-on unit parameter 121, which is backed up in the base unit internal memory 101, in the add-on unit 200 automatically. Hence, the parameter used in a replaced add-on unit can be inherited by a replacing add-on unit automatically.

As described above, combining the parameter setting processing and the start-up processing eliminates the need for a user to manually back up a parameter of the add-on unit. This allows a parameter to be inherited automatically once an add-on unit is replaced.

Note that the data backed up by the CPU 103 to the base unit internal memory 101 automatically and reflected in the add-on unit 200 automatically at the starting up of the remote unit may be adjustment information in place of a parameter. Examples of the adjustment information include offset and gain values in an analog unit. Additionally, the types of the add-on unit parameter 121 and the add-on unit parameter model name information 131 to be backed up in the base unit internal memory 101 may be increased such that add-on units of plural types can be backed up therein.

As described above, in the first embodiment, the base unit 100 includes the base unit internal memory 101, which stores an add-on unit parameter that is received from the programmable logic controller 10 through the field network 30 and determines the operation of the add-on unit 20, and the add-on unit 200 includes the CPU 202, which acquires from the base unit 100 the add-on unit parameter 121 stored in the base unit internal memory 101 and reflects it in the operation of the add-on unit 200. Hence, the need for a user to manually back up the add-on unit parameter 213 is eliminated, and once the add-on unit 200 is replaced, its parameter can be conveyed automatically.

In the above explanation, a configuration example in which a remote unit includes one add-on unit is described. However, a remote unit may include two or more add-on units. In the case of a remote unit including a plurality of add-on units, the add-on units can be identified by add-on unit parameter model name information such that an add-on unit parameter received from a programmable logic controller is reflected in an add-on unit for which the add-on unit parameter is suitable and the parameter used in a previous add-on unit is conveyed to an add-on unit that has replaced the previous add-on unit automatically.

### Second Embodiment

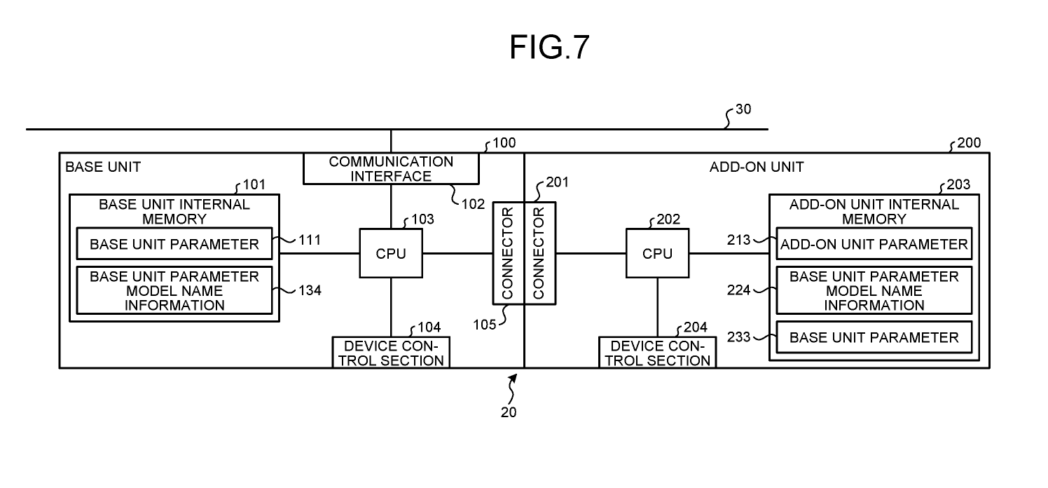

The configuration of a distributed control system according to a second embodiment of the present invention is similar to that of the distributed control system 50 according to the first embodiment illustrated in FIG. 1. FIG. 7 is a block diagram illustrating the configuration of a remote unit according to the second embodiment of the present invention. The difference from the remote unit 20 in the first embodiment is the information stored in a base unit internal memory 101 and an add-on unit internal memory 203. In the second embodiment, the base unit internal memory 101 stores a base unit parameter 111 and base unit parameter model name information 134. The add-on unit internal memory 203 stores a base unit parameter 233 in addition to an add-on unit parameter 213 and base unit parameter model name information 224. The base unit parameter model name information 224 is normally not rewritten to be changed.

In the second embodiment, a CPU 103 is a base unit central controller that performs processing of outputting to an add-on unit 200 a base unit parameter received from the programmable logic controller 10 through the field network 30 and causing the base unit parameter to be stored in the add-on unit internal memory 203, and also performs processing of, at starting up of the remote unit 20, acquiring from the add-on unit 200 the base unit parameter 233 stored in the add-on unit internal memory 203 and reflecting it in the operation of a base unit 100.

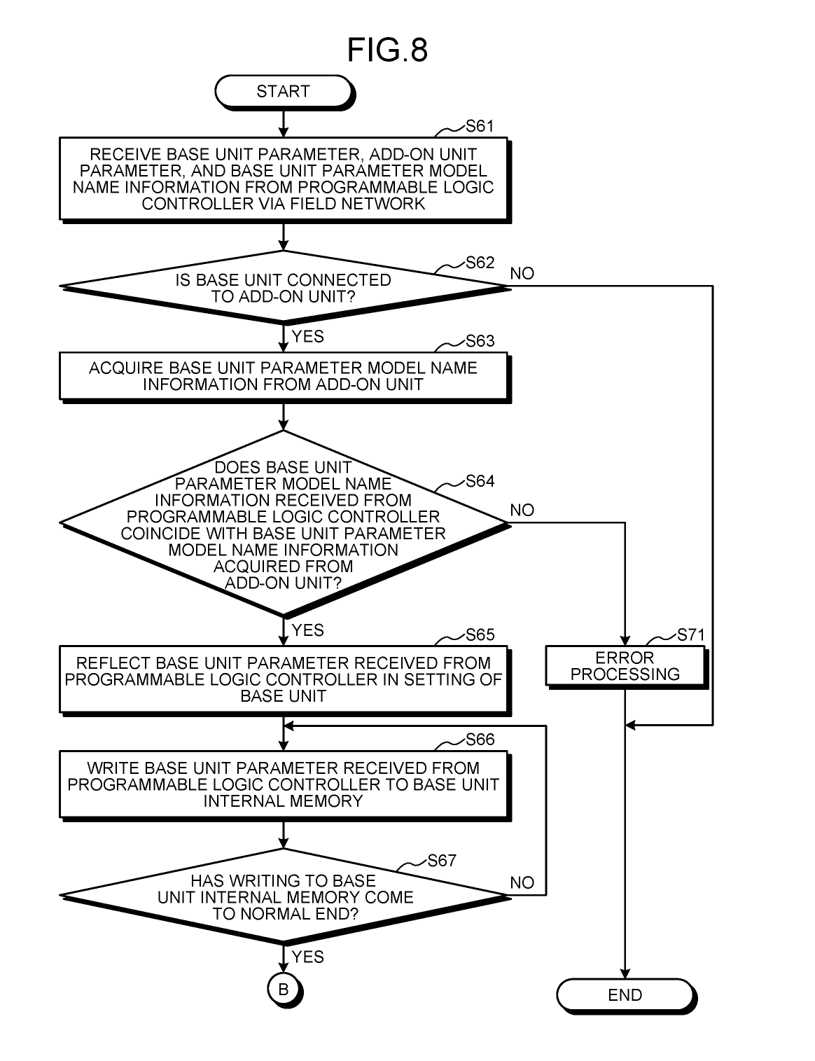

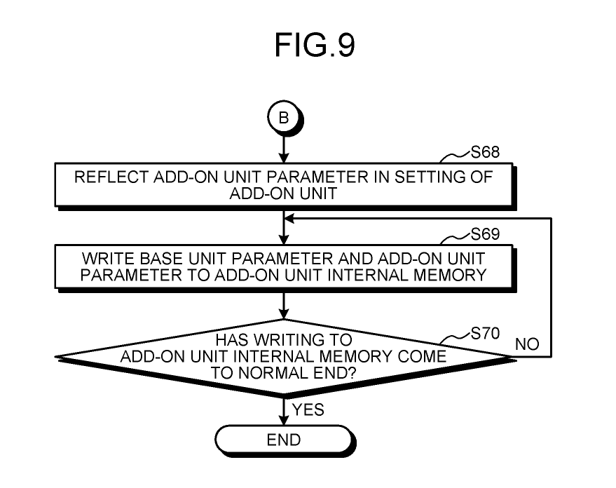

FIGS. 8 and 9 are flowcharts illustrating the flow of a parameter setting processing of the distributed control system according to the second embodiment. Here, it is assumed that parameters already set in the base unit 100 and the add-on unit 200 are updated for the explanation of the flow of the processing. In step S61, the CPU 103 receives a base unit parameter, an add-on unit parameter, and base unit parameter model name information from the programmable logic controller 10 via the field network 30. The base unit parameter model name information received by the CPU 103 indicates for which type of base units the base unit parameter received with the base unit parameter model name information is. Base unit parameter model name information is usually included in a base unit parameter.

In step S62, the CPU 103 checks whether the base unit 100 is connected to the add-on unit 200. If the base unit 100 is not connected to the add-on unit 200 (step S62: No), the parameter setting processing is finished. If the base unit 100 is connected to the add-on unit 200 (step S62: Yes), the flowchart proceeds to step S63.

In step S63, the CPU 103 acquires the base unit parameter model name information 224 from the add-on unit 200. Specifically, the CPU 103 requests the CPU 202 to read the base unit parameter model name information 224 stored in the add-on unit internal memory 203. In response to the request from the CPU 103, the CPU 202 reads the base unit parameter model name information 224 from the add-on unit internal memory 203 and transmits it to the CPU 103.

In step S64, the CPU 103 checks whether the base unit parameter model name information received from the programmable logic controller 10 coincides with the base unit parameter model name information 224 acquired from the add-on unit 200. If the base unit parameter model name information received from the programmable logic controller 10 coincides with the base unit parameter model name information 224 received from the CPU 202 (step S64: Yes), the flowchart proceeds to step S65. Note that, if the base unit parameter model name information received from the programmable logic controller 10 coincides with the base unit parameter model name information 224 acquired from the add-on unit 200, the base unit parameter received by the CPU 103 from the programmable logic controller 10 will be suitable for the base unit 100.

In step S65, the CPU 103 reflects the base unit parameter received from the programmable logic controller 10 in the setting of the base unit 100. That is, the CPU 103 uses the base unit parameter received from the programmable logic controller 10 for controlling the entire base unit 100. This enables the base unit 100 to operate according to the base unit parameter received from the programmable logic controller 10.

In step S66, the CPU 103 writes the base unit parameter received from the programmable logic controller 10 to the base unit internal memory 101. The base unit parameter written by the CPU 103 to the base unit internal memory 101 is the base unit parameter 111.

In step S67, the CPU 103 determines whether or not the writing into the base unit internal memory 101 has come to a normal end. If the writing into the base unit internal memory 101 has not come to the normal end (step S67: No), the flowchart returns to step S66 where the CPU 103 writes the base unit parameter received from the programmable logic controller 10 into the base unit internal memory 101. If the writing into the base unit internal memory 101 has come to the normal end (step S67: Yes), the flowchart proceeds to step S68.

In step S68, the CPU 103 transmits the base unit parameter and the add-on unit parameter received from the programmable logic controller 10 to the add-on unit 200. The CPU 202 reflects the add-on unit parameter received from the CPU 103 in the setting of the add-on unit 200. That is, the CPU 202 uses the add-on unit parameter that the base unit 100 has received from the programmable logic controller 10 for controlling the entire add-on unit 200. This enables the add-on unit 200 to operate according to the add-on unit parameter that the base unit 100 has received from the programmable logic controller 10.

In step S69, the CPU 202 writes the base unit parameter and the add-on unit parameter received from the base unit 100 to the add-on unit internal memory 203. The add-on unit parameter written by the CPU 202 to the add-on unit internal memory 203 is the add-on unit parameter 213. The base unit parameter written by the CPU 202 to the add-on unit internal memory 203 is the base unit parameter 233.

In step S70, the CPU 202 determines whether or not the writing into the add-on unit internal memory 203 has come to a normal end. If the writing into the add-on unit internal memory 203 has not come to the normal end (step S70: No), the flowchart returns to step S69 where the CPU 202 writes the base unit parameter and the add-on unit parameter received from the base unit 100 to the add-on unit internal memory 203. If the writing into the add-on unit internal memory 203 has come to the normal end (step S70: Yes), the processing is finished.

If the base unit parameter model name information received from the programmable logic controller 10 does not coincide with the base unit parameter model name information 224 acquired from the add-on unit 200 (step S64: No), the base unit parameter received by the CPU 103 from the programmable logic controller 10 will not be suitable for the base unit 100, and thus, in step S71, the CPU 103 performs error processing.

The disagreement between the base unit parameter model name information received from the programmable logic controller 10 and the base unit parameter model name information 224 acquired from the add-on unit 200 may be attributable to an input error made by a user of the distributed control system 50 when operating the engineering tool 60 to input the base unit parameter and the add-on unit parameter.

In the explanation above, the CPU 103 performs the error processing in step S71. However, the CPU 103 may perform no error processing and the CPU 103 may continue to operate using a previously set base unit parameter, that is, the base unit parameter 111 stored in the base unit internal memory 101. Alternatively, the CPU 103 may operate by using a default value stored in advance in the base unit 100.

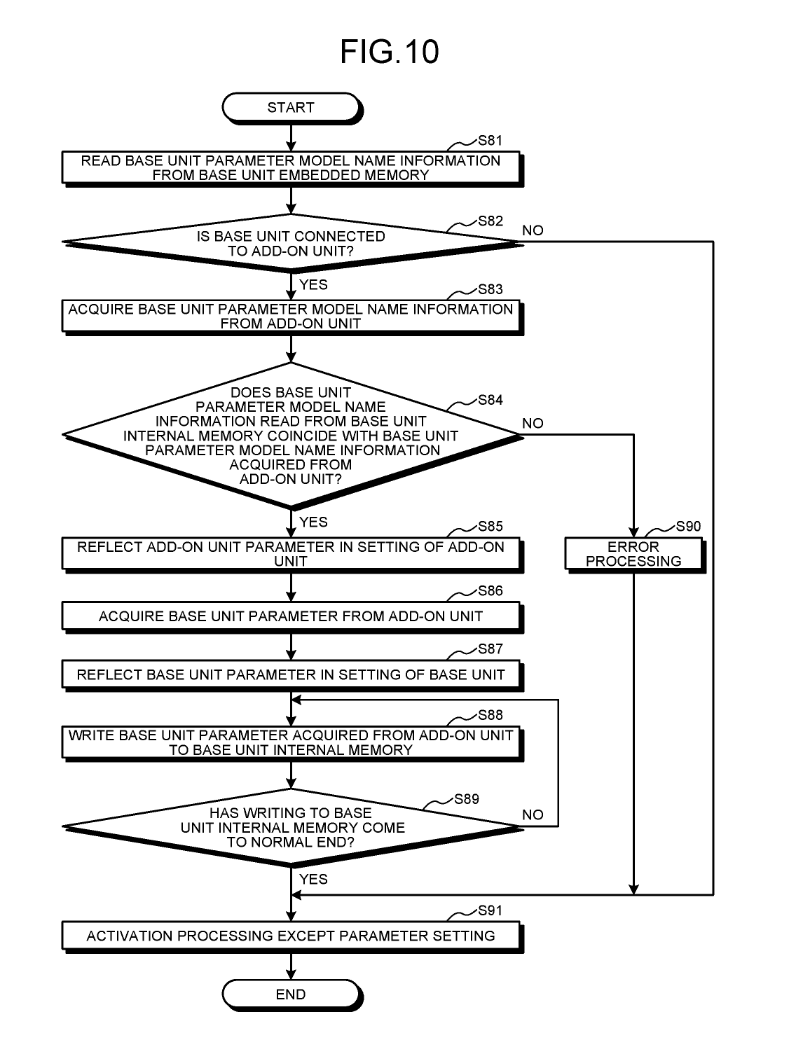

Start-up processing of the remote unit after the replacement of the base unit will now be described. FIG. 10 is a flowchart illustrating the flow of the start-up processing of the remote unit after the replacement of the base unit in the distributed control system according to the second embodiment. In step S81, the CPU 103 reads base unit parameter model name information 134 from the base unit internal memory 101.

In step S82, the CPU 103 checks whether an add-on unit 200 is connected to the base unit 100. If the add-on unit 200 is not connected to the base unit 100 (step S82: No), the flowchart proceeds to step S91. If the add-on unit 200 is connected to the base unit 100 (step S82: Yes), the flowchart proceeds to step S83.

In step S83, the CPU 103 acquires the base unit parameter model name information 224 from the add-on unit 200. Specifically, the CPU 103 requests the CPU 202 to read the base unit parameter model name information 224 stored in the add-on unit internal memory 203. In response to the request from the CPU 103, the CPU 202 reads the base unit parameter model name information 224 from the add-on unit internal memory 203 and transmits it to the CPU 103.

In step S84, the CPU 103 checks whether the base unit parameter model name information 134 read from the base unit internal memory 101 coincides with the base unit parameter model name information 224 acquired from the add-on unit 200. If the base unit parameter model name information 134 coincides with the base unit parameter model name information 224 (step S84: Yes), the flowchart proceeds to step S85.

In step S85, the CPU 202 reads the add-on unit parameter 213 from the add-on unit internal memory 203 and reflects it in the setting of the add-on unit 200. This enables the add-on unit 200 to operate according to the add-on unit parameter 213.

In step S86, the CPU 103 acquires the base unit parameter 233 from the add-on unit 200. Specifically, the CPU 103 requests the CPU 202 to read the base unit parameter 233 stored in the add-on unit internal memory 203. In response to the request from the CPU 103, the CPU 202 reads the base unit parameter 233 from the add-on unit internal memory 203 and transmits it to the CPU 103.

In step S87, the CPU 103 reflects the base unit parameter 233 in the setting of the base unit 100. This enables the base unit 100 to operate according to the base unit parameter 233.

In step S88, the CPU 103 writes the base unit parameter received from the add-on unit 200 to the base unit internal memory 101. The base unit parameter written by the CPU 103 to the base unit internal memory 101 is a base unit parameter 111.

In step S89, the CPU 103 determines whether or not the writing into the base unit internal memory 101 has come to a normal end. If the writing into the base unit internal memory 101 has not come to the normal end (step S89: No), the flowchart returns to step S88 where the CPU 103 writes the base unit parameter 233 received from the add-on unit 200 to the base unit internal memory 101. If the writing into the base unit internal memory 101 has come to the normal end (step S89: Yes), the flowchart proceeds to step S91.

If the base unit parameter model name information 134 read from the base unit internal memory 101 does not coincide with the base unit parameter model name information 224 received from the CPU 202 (step S84: No), the CPU 103 performs error processing in step S90, and then the flowchart proceeds to step S91.

The disagreement between the base unit parameter model name information 134 read from the base unit internal memory 101 and the base unit parameter model name information 224 received from the CPU 202 might have been caused by the fact that a user of the distributed control system 50 has replaced an add-on unit with another add-on unit of a different type.

In the explanation above, the CPU 103 performs the error processing in step S90. However, the CPU 103 may issue no error and operate using a default value stored in advance in the base unit 100.

In step S91, the CPU 103 performs start-up processing other than the parameter setting. In the case of the base unit 100 or the add-on unit 200 being an analog input unit, specific examples of the start-up processing other than the parameter setting include initial setting processing for hardware. In the case of the base unit 100 or the add-on unit 200 being an analog output unit, its specific examples include a charging time setting for a capacitor.

As described above, the remote unit reflects the base unit parameter 233, which is backed up in the add-on unit internal memory 203, in the base unit 100 automatically. Hence, the parameter used in a previous base unit can be automatically conveyed to a base unit that has replaced.

As described above, combining the parameter setting processing and the start-up processing eliminates the need for a user to manually back up a parameter of the base unit 100. This allows a parameter to be inherited automatically once the base unit 100 is replaced.

Note that the data backed up by the CPU 202 to the add-on unit internal memory 203 automatically and reflected in the base unit 100 automatically at the starting up of the remote unit may be adjustment information in place of a parameter. Examples of the adjustment information include offset and gain values in an analog unit. Additionally, the types of the base unit parameter 233 to be backed up in the add-on unit internal memory 203 may be increased such that the base units of plural types can be backed up therein.

In the above explanation, a configuration example in which a remote unit includes one add-on unit is described. However, a remote unit may include two or more add-on units. In the case of a remote unit including a plurality of add-on units, if a base unit parameter is written into the add-on unit internal memory of any of the add-on units, the base unit parameter received from a programmable logic controller and applied in a previous base unit is automatically conveyed to another base unit that has replaced the previous base unit.

In the second embodiment, the add-on unit 200 includes the add-on unit internal memory 203, which stores the base unit parameter 233 that determines the operation of the base unit 100, and the base unit 100 includes the CPU 103, which acquires from the add-on unit 200 the base unit parameter 233 stored in the add-on unit internal memory 203 and reflects it in the operation of the base unit 100. Hence, the need for a user to manually back up the base unit parameter 111 is eliminated, and once the base unit 100 is replaced, its parameter can be inherited automatically.

Note that the first and second embodiments can be combined such that a base unit parameter is backed up in an add-on unit internal memory and an add-on unit parameter is backed up in a base unit internal memory. By backing up a base unit parameter in the add-on unit internal memory and backing up the add-on unit parameter in the base unit internal memory, the parameters can be conveyed automatically when any of the base unit and the add-on unit is replaced.

### Third Embodiment

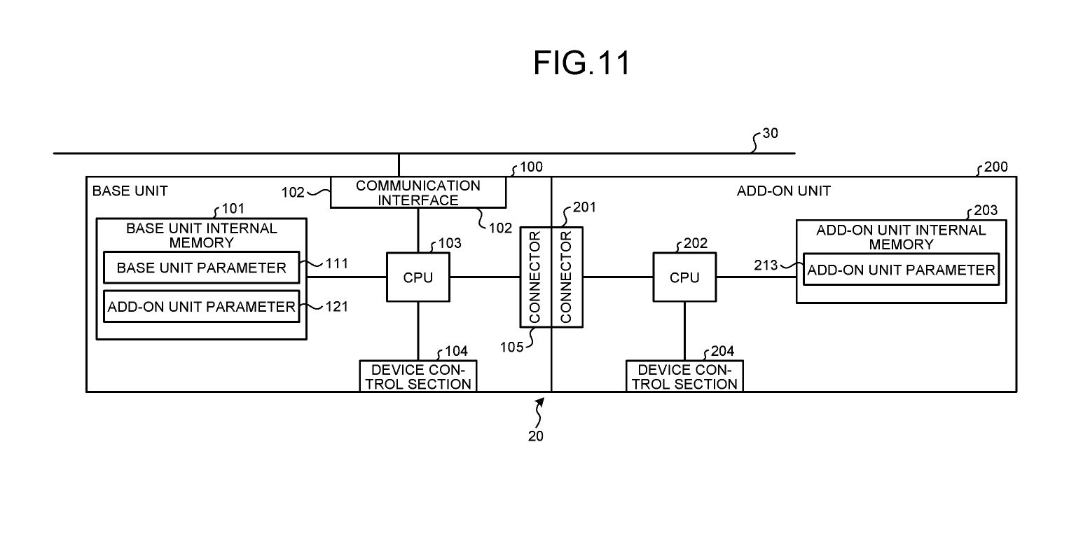

FIG. 11 is a block diagram illustrating the configuration of a remote unit according to a third embodiment of the present invention. The difference from the remote unit 20 in the first embodiment is the information to be stored in a base unit internal memory 101 and an add-on unit internal memory 203. In the third embodiment, the base unit internal memory 101 stores a base unit parameter 111 and an add-on unit parameter 121. The add-on unit internal memory 203 stores an add-on unit parameter 213.

In the third embodiment, a base unit 100 can be connected to a unique type of add-on unit 200. The word connect here refers to a state in which communication with the base unit 100 is possible and does not include a state in which they are merely coupled physically.

A CPU 103 in the base unit 100 and a CPU 202 in the add-on unit 200 of an only type connectable to the base unit 100 have a function to communicate using a sole communication protocol. Hence, when an add-on unit of another type, which is different from the only type that is connectable, is coupled to the base unit 100, no communication can be achieved using the sole communication protocol described above.

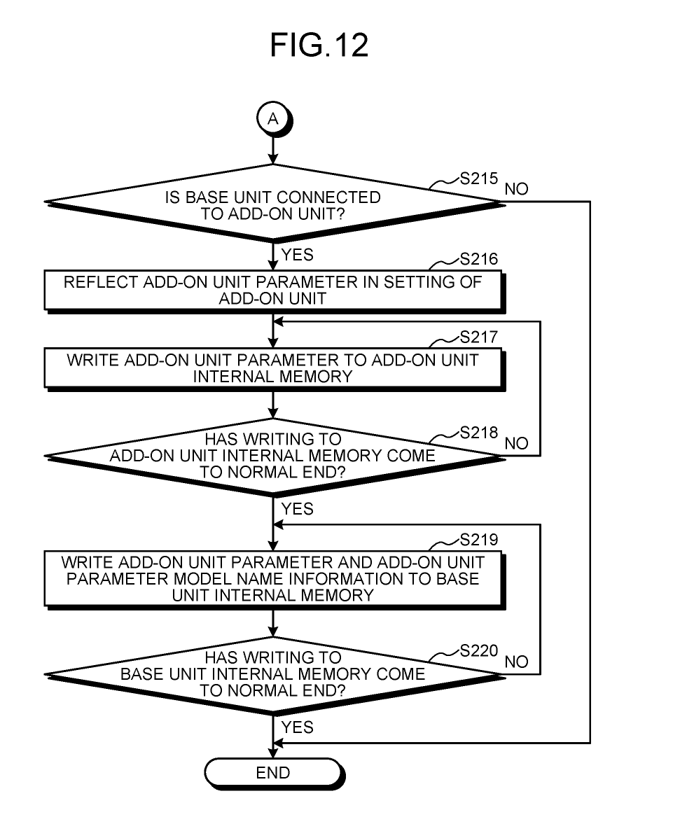

FIG. 12 is a flowchart illustrating the flow of parameter setting processing of a distributed control system according to the third embodiment. Here, it is assumed a case in which parameters already set in the base unit 100 and the add-on unit 200 are updated for the description of the flow of the processing. The operations in and before step S215 are similar to those in steps S11 to S14 in the first embodiment illustrated in FIG. 4 and their illustration and description is omitted.

In step S215, the CPU 103 checks whether the add-on unit 200 is connected to the base unit 100. In addition to checking whether the add-on unit 200 is connected to the base unit 100, the CPU 103 determines whether or not the add-on unit 200 is connected to the base unit 100 based on whether the communication with the CPU 202 is possible by using the sole communication protocol described above. Specifically, the CPU 103 transmits a message to the CPU 202 with the sole communication protocol described above and, if there is a response from the CPU 202, determines that the add-on unit 200 is connected to the base unit 100.

If the add-on unit 200 is not connected to the base unit 100 (step S215: No), the parameter setting processing is finished. If the add-on unit 200 is connected to the base unit 100 (step S215: Yes), the flowchart proceeds to step S216.

In step S216, the CPU 103 transmits an add-on unit parameter received from the programmable logic controller 10 to the add-on unit 200. The CPU 202 reflects the add-on unit parameter received from the CPU 103 in the setting of the add-on unit 200. That is, the CPU 202 uses the add-on unit parameter that the base unit 100 has received from the programmable logic controller 10 for controlling the entire add-on unit 200. This enables the add-on unit 200 to operate according to the add-on unit parameter that the base unit 100 has received from the programmable logic controller 10.

The processing in and after step S217 is similar to that in and after step S19 in the first embodiment and the duplicate description is omitted.

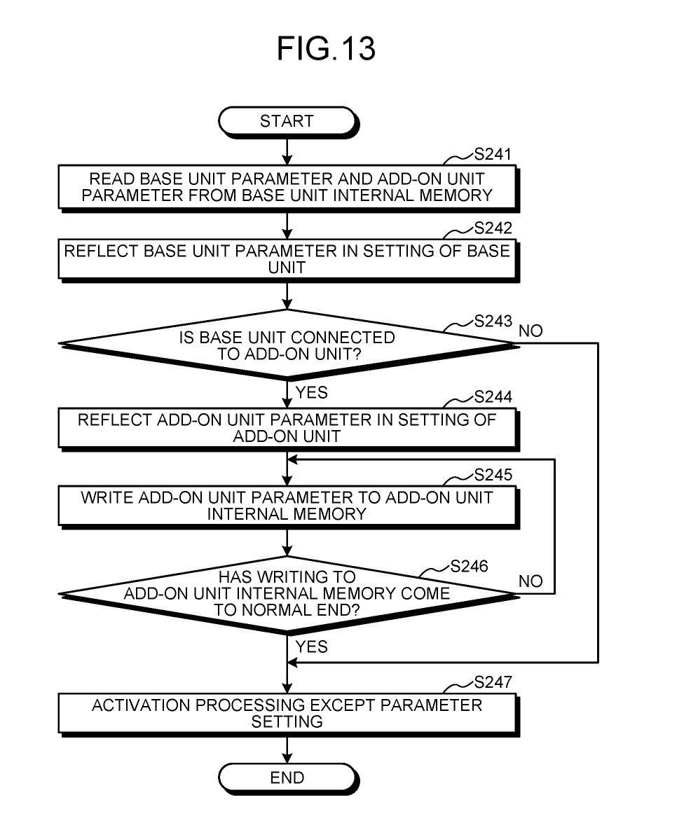

Start-up processing of the remote unit after the replacement of the add-on unit will now be described. FIG. 13 is a flowchart illustrating the flow of the start-up processing of the remote unit after the replacement of the add-on unit in the distributed control system according to the third embodiment. In step S241, the CPU 103 reads the base unit parameter 111 and the add-on unit parameter 121 from the base unit internal memory 101.

In step S242, the CPU 103 reflects the base unit parameter 111 in the setting of the base unit 100. This enables the base unit 100 to operate according to the base unit parameter 111.

In step S243, the CPU 103 checks whether the add-on unit 200 is connected to the base unit 100. If the add-on unit 200 is not connected to the base unit 100 (step S243: No), the flowchart proceeds to step S247. If the add-on unit 200 is connected to the base unit 100 (step S243: Yes), the flowchart proceeds to step S244.

In step S244, the CPU 103 transmits the add-on unit parameter 121 read from the base unit internal memory 101 to the CPU 202. The CPU 202 reflects the add-on unit parameter 121 received from the CPU 103 in the setting of the add-on unit 200. This enables the add-on unit 200 to operate according to the add-on unit parameter 121 received from the programmable logic controller 10.

In step S245, the CPU 202 writes the add-on unit parameter received from the base unit 100 to an add-on unit internal memory 203. The add-on unit parameter written by the CPU 202 into the add-on unit internal memory 203 is an add-on unit parameter 213.

In step S246, the CPU 202 determines whether or not the writing into the add-on unit internal memory 203 has come to a normal end. If the writing into the add-on unit internal memory 203 has not come to the normal end (step S246: No), the flowchart returns to step S245 where the CPU 202 writes the add-on unit parameter received from the base unit 100 to the add-on unit internal memory 203. If the writing into the add-on unit internal memory 203 has come to the normal end (step S246: Yes), the flowchart proceeds to step S247.

In step S247, the CPU 103 performs start-up processing other than the parameter setting. In the case of the base unit 100 or the add-on unit 200 being an analog input unit, specific examples of the start-up processing other than the parameter setting include an initial setting processing for hardware. In the case of the base unit 100 or the add-on unit 200 being an analog output unit, its specific examples include a charging time setting for a capacitor.

In the third embodiment, to the base unit 100, only the add-on unit 200 of a unique type that is connectable to the base unit 100 can communicate with the base unit, and when connected to the base unit 100, the add-on unit 200 acquires from the base unit 100 the add-on unit parameter that the base unit 100 has received from the programmable logic controller 10. When the add-on unit 200 of the unique type that can communicate with the base unit 100 is connected to the base unit 100, the model name of the add-on unit 200 is uniquely determined. Hence, unlike the first embodiment, the need for the processing to investigate the model name of the add-on unit 200 by the add-on unit parameter model name information is eliminated. That is, only by connecting the add-on unit 200 to the base unit 100, the add-on unit parameter 213 of the add-on unit 200 can be updated without the need for a separate checking unit.

In the example described above, it is determined whether the add-on unit is of a specific model name according to whether or not communication by the sole communication protocol is possible. However, it can be arranged such that the surface on which the base unit and the add-on unit abut with each other is made in an unique shape such that no other add-on units than the one having a specific model name can connect with the base unit because of a physical interference caused therebetween, which prevents their connectors from being connected.

Note that, as in the second embodiment, a base unit parameter can also be backed up in the add-on unit internal memory. Additionally, a base unit parameter can be backed up in the add-on unit internal memory and an add-on unit parameter can be backed up in the base unit internal memory. By backing up the base unit parameter in the add-on unit internal memory and backing up the add-on unit parameter to the base unit internal memory, the parameter can be inherited automatically when any of the base unit and the add-on unit is replaced.

### REFERENCE SIGNS LIST

10 programmable logic controller, 20, 21 remote unit, 30 field network, 40 control-target device, 50 distributed control system, 60 engineering tool, 70 control network, 100 base unit, 101 base unit internal memory, 102 communication interface, 103, 202 CPU, 104, 204 device control section, 105, 201 connector, 111, 233 base unit parameter, 121, 213 add-on unit parameter, 131, 223 add-on unit parameter model name information, 134, 224 base unit parameter model name information, 200 add-on unit, 203 add-on unit internal memory.

1. A control apparatus for use in a distributed control system, the control apparatus being connected through a network to a controller to serve as a master station and serving as a remote station of the distributed control system, the control apparatus comprising:
a base unit having a function to communicate through the network and an add-on unit connected to the network through the base unit, wherein
the base unit includes a base unit central controller to receive from the controller through the network an add-on unit parameter that determines an operation of the add-on unit and a base unit internal memory to store the add-on unit parameter received from the controller, and
the add-on unit includes an add-on unit central controller to acquire, at starting up of the control apparatus for use in a distributed control system, from the base unit the add-on unit parameter stored in the base unit internal memory and to reflect the add-on unit parameter in the operation of the add-on unit.

2. The control apparatus for use in a distributed control system according to claim 1, wherein the base unit stores add-on unit parameter model name information that indicates a type of the add-on unit in the base unit internal memory, and
when add-on unit parameter model name information that the base unit has received together with the add-on unit parameter from the controller coincides with the add-on unit parameter model name information stored in the base unit internal memory, the add-on unit acquires from the base unit the add-on unit parameter that the base unit has received together with the add-on unit parameter model name information from the controller.

3. The control apparatus for use in a distributed control system according to claim 1, wherein the base unit is connectable to the add-on unit of a unique type, and
when the add-on unit is connected to the base unit, the add-on unit acquires from the base unit the add-on unit parameter that the base unit has received from the controller.

4. The control apparatus for use in a distributed control system according to claim 1, wherein the add-on unit comprises an add-on unit internal memory to store a base unit parameter that determines an operation of the base unit, and
the base unit comprises the base unit central controller to acquire from the add-on unit the base unit parameter stored in the add-on unit internal memory and reflects the base unit parameter in the operation of the base unit.

5. A control apparatus for use in a distributed control system, the control apparatus being connected through a network to a controller to serve as a master station and serving as a remote station of the distributed control system, the control apparatus comprising:
a base unit having a function to communicate through the network; and an add-on unit connected to the network through the base unit, wherein
the add-on unit includes an add-on unit internal memory to store a base unit parameter that determines an operation of the base unit, and the base unit includes a base unit central controller, the base unit central controller performing processing of:
outputting to the add-on unit the base unit parameter received from the controller through the network and causing the base unit parameter to be stored in the add-on unit internal memory; and
acquiring, at starting up of the control apparatus for use in a distributed control system, from the add-on unit the base unit parameter stored in the add-on unit internal memory and reflecting the base unit parameter in the operation of the base unit.

6. A unit included in a control apparatus for use in a distributed control system, the unit being connected through a network to a controller to serve as a master station and serving as a remote station of the distributed control system, wherein
the unit has a function to communicate through the network and causes an add-on unit to be connected to the network when the unit is connected to the add-on unit, and comprises:
a central controller to receive from the controller through the network an add-on unit parameter that determines an operation of the add-on unit; and
a memory to store the add-on unit parameter received from the controller, and wherein
the unit transmits, at starting up of the control apparatus for use in a distributed control system, to the add-on unit the add-on unit parameter stored in the memory.
